(19) United States
(12) Patent Application Publication
(10) Pub. No.: US 2024/0339270 A1
(43) Pub. Date: Oct. 10, 2024

(54) DUAL POWER TRANSFER SWITCH

(71) Applicant: ABB SCHWEIZ AG, Baden (CH)

(72) Inventors: Jianwei Li, Jiangmen (CN); Huaming Xia, Zhangzhou (CN); Yihua Chen, Xiamen (CN); Deyun Zhang, Xiamen (CN)

(21) Appl. No.: 18/746,201

(22) Filed: Jun. 18, 2024

Related U.S. Application Data
(63) Continuation of application No. PCT/CN2022/074808, filed on Jan. 28, 2022.

(51) Int. Cl. H01H 9/26; H02B 1/30; H02J 9/06

(52) U.S. Cl. CPC H01H 9/26; H02B 1/30; H02J 9/06; H01H 2300/018

(57) ABSTRACT

A dual power transfer switch includes a first switch for connecting a first power source to a load and a second switch for connecting a second power source to a load, a user interface configured to receive a user's operating handle for operating the dual power transfer switch, and an interlock device comprising an interlock member which is adapted to act on the user interface to prevent or allow a user to operate the dual power transfer switch through the user interface in accordance with states of the first switch and the second switch. Further, the interlock member is configured to move to different positions so as to lock or unlock the user interface in dependence on different rotation positions of a main shaft of the dual power transfer switch.

### FIELD

Embodiments of the present disclosure generally relate to the field of a dual power transfer switch, and more particularly, to a dual power transfer switch with interlock devices.

### BACKGROUND

A dual power transfer switch is widely used in a power distribution cabinet for changeover of two power supplies to ensure continuously providing power to critical loads. A bypass type device typically contains two dual power transfer switches, i.e., a first transfer switching equipment (TSE, also referred to as a dual power transfer switch) and a second transfer switching equipment, each of which comprises two switches to switch the loads between the two power supplies. The first transfer switching equipment and the second transfer switching equipment are substantially the same and one is used to operate in a normal condition in which the loads receive power from mains supply and the other is used to operate in a maintenance condition in which the first transfer switching equipment needs maintenance and the loads receive power from a backup power supply (for example a generator).

The dual power transfer switch is generally implemented as a drawer which can be drawn in or out of the power distribution cabinet. A user interface is provided on the dual power transfer switch which allows a user to operate the dual power transfer switch, for example, to draw the dual power transfer switch out of the cabinet, and the like. In many situations, for example, when the switch of the dual power transfer switch is at an ON state, the user is not allowed to draw the dual power transfer switch out of the power distribution cabinet. There is a need to improve safety operations of the TSE.

### SUMMARY

Example embodiments of the present disclosure provide a dual power transfer switch which can improve operation safety of the device by providing an interlock function.

In a first aspect of the present disclosure, it is provided a dual power transfer switch. The dual power transfer switch comprises a first switch for connecting a first power source to a load, a second switch for connecting a second power source to a load, a user interface configured to receive a user's operating handle for operating the dual power transfer switch, and an interlock device comprising an interlock member which is adapted to act on the user interface to prevent or allow a user to operate the dual power transfer switch through the user interface in accordance with states of the first switch and the second switch, wherein the interlock member is configured to move to different positions so as to lock or unlock the user interface in dependence on different rotation positions of a main shaft of the dual power transfer switch.

According to the present disclosure, during operation of the dual power transfer switch, the interlock member can move to different positions in dependence on different rotation positions of a main shaft of the dual power transfer switch so as to so as to lock or unlock the user interface. Accordingly, the user interface can be interlocked in dependence on different rotation positions of a main shaft of the dual power transfer switch, which improves the safety of the dual power transfer switch.

In some embodiments, the dual power transfer switch comprises a charging system and a contact system, the charging system comprising a charging main shaft and a charging spring for rotating the charging main shaft, the charging main shaft being configured to drive a contact main shaft of the contact system to switch ON/OFF states of the first switch and the second switch; wherein the interlock member is configured by driven by the charging main shaft via a driving device connected thereto. With this arrangement, the user interface can be interlocked in dependence on different rotation positions of a charging main shaft of the dual power transfer switch. This makes it possible to easily realize the interlock function of the interlock device.

In some embodiments, interlock device comprises a driving device comprising a first link ratably and eccentrically mounted to the charging main shaft and a transmission assembly driven by the first link to convert a rotational movement of the main shaft to a linear movement for moving the interlock member. With the arrangement, the space efficiency of the interlock device can be improved.

In some embodiments, the dual power transfer switch further comprises a mounting plate for carrying the charging system provided with a through hole, wherein the charging main shaft is disposed on a first side of the mounting plate, and the first link extends through the through hole to a second side opposite to the first side, wherein the transmission assembly is disposed on the second side. With the arrangement, the space occupied by the interlock device is further reduced and also normal operation of the charging system is not affected by the provision of the interlock device.

In some embodiments, the transmission assembly comprises a rack and pinion mechanism including a pinion and a rack that engages with the pinion, the first link being eccentrically and rotatably mounted to the pinion. With this arrangement, the interlock member can be linearly moved with a simple configuration.

In some embodiments, the transmission assembly further comprises a driving member fixed thereto comprising a drive portion protruding from the driving member in a direction perpendicular to a linear movement direction of the driving member, the drive portion being configured to actuate the interlock member. With this arrangement, the space occupied by the interlock device is further reduced. Also, the interlock member can be reliably achieved.

In some embodiments, the driving device further comprises a movable body disposed between the driving member and the interlock member, the movable body being configured to be driven by the driving member and then to move the interlock member. With the movable body, it provides more freedom of designs for moving the interlock member.

In some embodiments, the movable body further comprises an electromagnetic actuator, wherein the electromagnetic actuator is configured to drive the interlock member in response to an input signal to the electromagnetic actuator regardless of a rotation position of the charging main shaft. With this arrangement, the interlock member can be controlled independently regardless of the rotation positions of the main shaft.

In some embodiments, the charging main shaft has a first rotation position and a second rotation position corresponding to an ON state of the first switch and the second switch respectively, and a third rotation position and a fourth rotation position between the first rotation position and the second rotation position which correspond to an OFF state of the first switch and the second switch respectively, and wherein the interlock member is configured to lock the user interface to prevent the user from operating the user interface when the first switch and the second switch are at the ON state; and the interlock member is configured to unlock the user interface to allow the user to operate the user interface when the first switch and the second switch are at the OFF state. With this arrangement, when the switch is at the ON state, the user interface is locked by the interlock member and when the switch is at the ON state, the user interface is unlocked by the interlock member.

In some embodiments, the drive portion comprises a pair of protruding portions sequentially arranged along the linear movement direction, the pair of protruding portions being laterally staggered from each other such that the interlock member is actuated by different protruding portion at different linear positions of the driving member. With the arrangement, the interlock member can by moved by a reciprocating motion of the drive member and a linear motion of the drive time at a time can drive the interlock member two times.

In some embodiments, the movable body includes a matching protruding portion arranged opposite to the protruding portion, the matching protruding portion being configured to be pushed by the protruding portion so as to move the movable body in a direction perpendicular to the linear movement direction. This can improve smooth movements of the movable body. In some embodiments, the interlock member is rotatably mounted to the user interface.

In a second aspect of the present disclosure, it is provided a power distribution cabinet. The power distribution cabinet comprises: a first power supply terminal for receiving a first power from a first power supply; a second power supply terminal for receiving a second power from a second power supply; a load terminal for outputting a power to a load; at least one dual power transfer switch according to any of the above mentioned first and second aspects configured to selectively connect the first power terminal or the second power terminal to the load terminal.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic view of a bypass device including two TSEs showing operation principles of the device.

FIG. 2 schematically illustrates a perspective view of a TSE with an interlock device viewed from a charging main shaft side according to an embodiment of the present disclosure;

FIG. 3 schematically illustrates a perspective view of a TSE with an interlock device viewed from a back side of FIG. 2;

FIG. 4 schematically illustrates a perspective view of a TSE with an interlock device according to an embodiment of the present disclosure;

FIG. 5 schematically illustrates a view of a TSE with an interlock device according to an embodiment of the present disclosure with a with a first switch at on ON state and an interlock member at a locked position;

FIG. 6 schematically illustrates a view of a TSE with an interlock device according to an embodiment of the present disclosure with a with a second switch at OFF state and an interlock member at a unlocked position;

FIG. 7 schematically illustrates a view of a TSE with an interlock device according to an embodiment of the present disclosure with a with a first switch at OFF state and an interlock member at a unlocked position;

FIG. 8 schematically illustrates a view of a TSE with an interlock device according to an embodiment of the present disclosure with a with a second switch at ON state and an interlock member at a locked position;

FIG. 9 schematically illustrates a closed up view of the driving member of the interlock device according to an embodiment of the present disclosure;

FIG. 10 schematically illustrates a closed up view of the movable body of the interlock device according to an embodiment of the present disclosure;

FIG. 11 schematically illustrates a exploded view of the movable body of the interlock device according to an embodiment of the present disclosure;

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

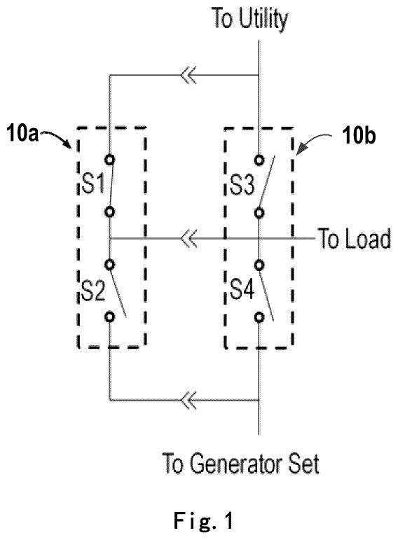

First of all, an application scenario according to an embodiment of the present disclosure will be described with reference to FIG. 1. As shown in FIG. 1, a bypass device comprises two dual power transfer switches 10a, 10b (also referred to as transfer switching equipment, TSE). The two TSEs 10a, 10b are substantially the same and are implemented as a drawer which can be slidably arranged in a power distribution cabinet. A first TSE 10a comprises a first switch S1 and a second switch S2, and the second TSE 10b comprises a third switch S3 and a fourth switch S4. Terminals of the first switch S1 and the third switch S3 are connected to a main power supply, for example, the utility or mains supply, and the second switch S2 and the fourth switch S4 are connected to an auxiliary power supply, for example, a generator set.

During a normal condition, the first TSE 10a is used to switch the load between the main power supply and the auxiliary power supply. That is, when the main power supply is a normal state, the first switch S1 is closed (also referred to as being switched on) and the second switch S2 is opened (also referred to as being switched off), such that the load is powered by the main power supply; when the main power supply is an abnormal state, the first switch S1 is opened and the second switch S2 is closed, such that the load is powered by the auxiliary power supply. In this situation, the third switch S3 and the fourth switch S4 of the second TSE 10b both are opened.

The two TSEs 10a, 10b may operate in an automatic mode and a manual mode. In the automatic mode, the TSEs operate automatically according to a programmed logic to ensure proper operations of the device. In the manual mode, the TSE can receive user's input via operation interface 70, for example, to convert a state of the switch therein in case of maintenance.

When the first TSE needs maintenance, both the first and second switches S1, S2 should be open before any actions are taken by a user. However, the user may mistakenly take actions to operate the first and second switches S1, S2 so as to convert a state of the first and second switches S1, S2 to be closed. In the event that any of the first and second switches S1, S2 is closed, when the user swung out the drawer (i.e, the TSE), it is dangerous and may cause casualties. Thus, there is a need to prevent the user's wrong operations. On the other hand, when the first TSE 10a needs maintenance, one of the third and fourth switches S3, S4 of the second TSE 10b should be closed and the other should be open to ensure continuous power supply to the loads. However, the user may mistakenly take actions to operate the third and fourth switches S3, S4 so as to convert both the third and fourth switches S3, S4 to be open. This may cause an interruption of power supply to the critical loads. Thus, there is also a need to prevent the user's wrong operations.

Likewise, when the second TSE needs maintenance, both the third and fourth switches S3, S4 should be open before any actions are taken by a user. However, the user may mistakenly take actions to operate the third and fourth switches S3, S4 so as to convert a state of the third and fourth switches S3, S4 to be closed. Thus, there is a need to prevent the user's wrong operations. On the other hand, as the second TSE needs maintenance, one of the first and second switches S1, S2 should be closed and the other should be open to ensure continuous power supply to the loads. However, the user may mistakenly take actions to operate the first and second switches S1, S2 so as to convert both the first and second switches S1, S2 to be open. Thus, there is also a need to prevent the user's wrong operations.

According to one embodiment of the present disclosure, it is provided a dual power transfer switch with interlock functions which can prevent user's wrong operations of the device. An interlock device is provided for interlocking the user interface. The interlock device is configured to lock or unlock the user interface in dependence on the states of the dual power transfer switch. For example, when one of the switches S1, S2 of first TSE is at ON state (closed), the user interface cannot be operated by the user due to provision of the interlock device which locks the user interface. Only when both the switches S1, S2 of first TSE is at OFF state (open), the user interface is allowed to be operated by the user due to provision of the interlock device which unlocks the user interface. Likewise, when one of the switches S3, S4 of second TSE is at ON state (closed), the user interface cannot be operated by the user since the interlock device locks the user interface. Only when both the switches S3, S4 of second TSE is at OFF state (open), the user interface is allowed to be operated by the user since the interlock device which unlocks the user interface. It is to be understood that the interlock functions may be applicable to any TSE of the bypass device.

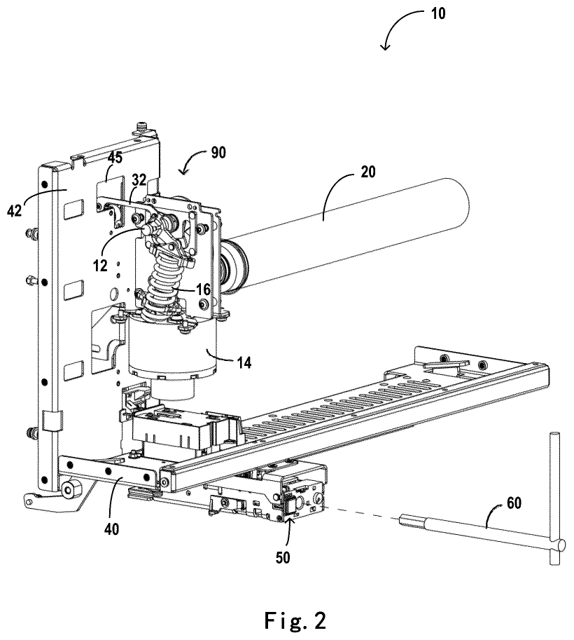

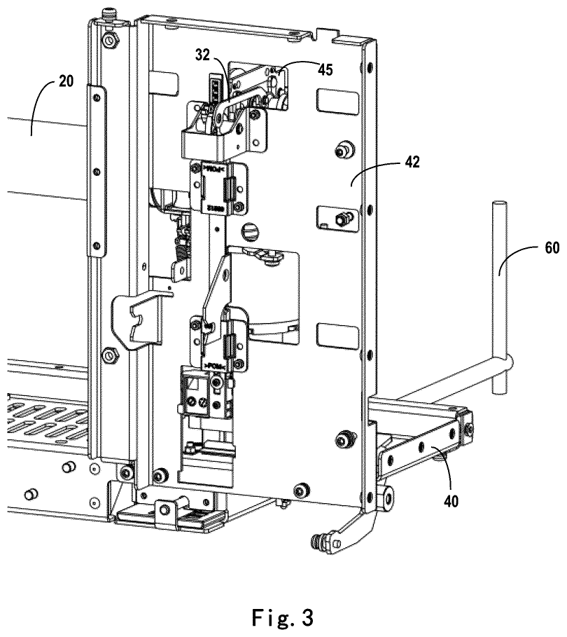

FIGS. 2 and 3 schematically illustrate a perspective view of a TSE 1 according to an embodiment of the present disclosure viewed. As shown in FIGS. 2 and 3, the TSE 1 is arranged on a carriage 40 (in shown example, only part of the carriage is shown) and is implemented as a drawer. The TSE 1 moves along a guide rail in a power distribution cabinet. For sake of clarity, the power distribution cabinet is shown in the figures.

The TSE 1 includes a contact system and a charging system 10 for driving the movable contact assemblies of the contact system. Both the contact system and a charging system 10 are provided on the carriage 40 which can be moved by operation of a user interface 50. The contact system includes a movable contact, a first fixed contact for connecting to a first power supply, and a second fixed contact for connecting to a second power supply. The movable contact can be driven by a contact main shaft 20 which is rotatably arranged on the carriage. Accordingly to the phase numeral of the TSE, the number of the movable contacts, the number of the first fixed contacts, and the number of the second fixed contacts vary. During operation of the TSE 1, a rotation of the contact main shaft 10 causes the movable contact via a contact link mechanism to be located at different positions. The contact main shaft 10 includes a first closed position, a second closed position, and an open position, wherein at the first closed position, the contact assemblies connect a first power source to a load; at the second closed position, the contact assemblies connect a second power source to the load, and at the open position, the contact assemblies disconnects both the first power supply and the second power supply from the load. As these contact assemblies and the associated contact link mechanisms are well known in the art and are omitted in the figures in order not to obscure the principle of the invention.

The charging system 10 includes a charging main shaft 12 and a charging spring 16. The charging spring 16 can be operated to automatically store energy via operation of an actuator 14. During operation of the charging system 10, the charging spring 16 is firstly charged. The charging spring 16 drives the charging main shaft 12 to rotate through energy release of the charging spring 16 and a rotation of the charging main shaft 12 further causes the contact main shaft 20 to rotate via a transmission mechanism. The charging main shaft 12 includes a first energy release position, a second energy release position and a charging position between the first energy release position and the second energy release position. In some embodiments, the first energy release position is corresponding to the first closed position of the contact main shaft 20, the second energy release position is corresponding to the second closed position of the contact main shaft 20, and the charging position is located between the first energy release position and the second energy release position.

The TSE 1 further includes a user interface 50 which serves as interface for user's manual operation. The user can operate the user interface 50 to operate the TSE 1. As an example, the user interface 50 can include an opening. A user's handle 60 can be received in the opening. When the handle 60 is inserted in the opening in position, the user can operate the TSE 1, by rotating the handle 60, for example, to draw the TSE 1 into or out of the cabinet. In some embodiments, the user interface 50 may include a shutter (not shown) for closing the opening of the user interface 50 and a motion actuator (not shown) for moving the shutter.

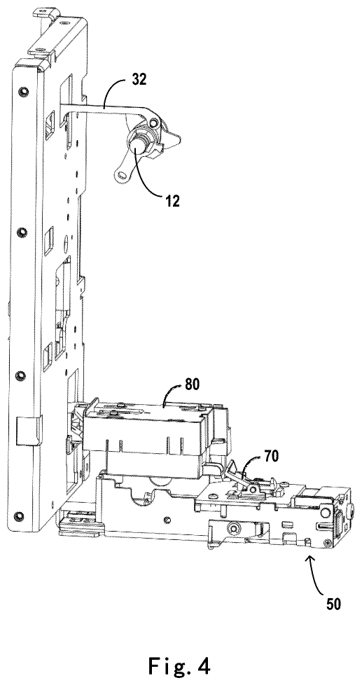

The TSE 1 further includes an interlock device 90. FIG. 4 schematically illustrates a perspective view of a TSE 1 with an interlock device according to an embodiment of the present disclosure. As shown in FIG. 4, the interlock device 90 includes an interlock member 70 which is adapted to act on the user interface 50 to prevent or allow a user to operate the dual power transfer switch through the user interface 50 in accordance with states of the first switch and the second switch. The interlock member 70 is configured to move to different positions so as to lock or unlock the user interface 50 in dependence on different rotation positions of a main shaft of the dual power transfer switch. By movement of the interlock member 70, the user interface 50 can be interlocked with respect to the operation states of the switches of the TSE.

In some embodiments, as shown, the interlock member 70 is rotatably mounted to the user interface 50. Thus, by rotating the interlock member 70, the user interface 50 can be locked or unlocked. It is to be understood that this is merely exemplary rather limited. In some embodiments, the interlock member 70 can lock the user interface 50 via linear movement. In addition, the interlock member 70 may have ways for locking the user interface. For example, the interlock member 70 can act upon the motion actuator. When the interlock member 70 engages with the motion actuator, the motion actuator cannot move the shutter. When the interlock member 70 disengages from the motion actuator, the motion actuator is allowed to move the shutter. It is to be understood that this is merely exemplary rather limited, the interlock member 70 may act upon other parts of the user interface 50 to realize the same function.

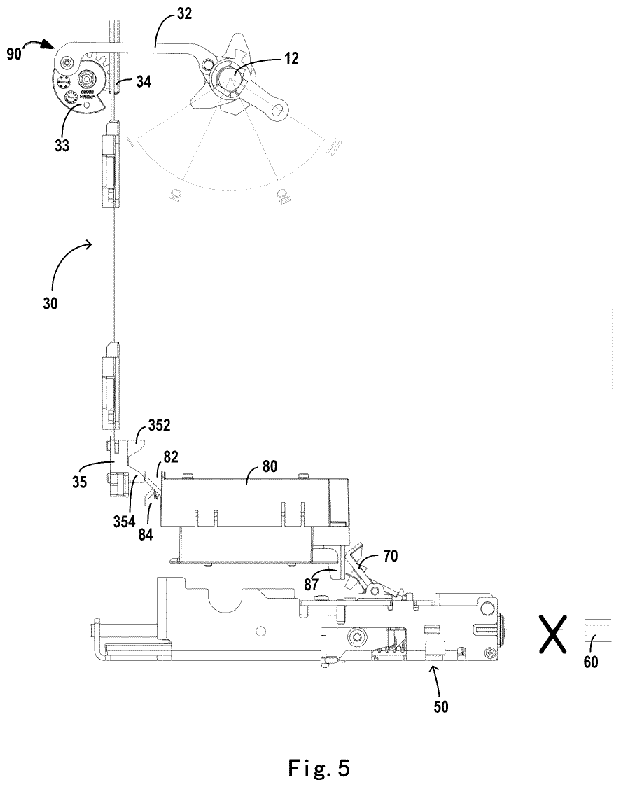

FIG. 5 schematically illustrates a view of a TSE with an interlock device 90 according to an embodiment of the present disclosure. As shown FIG. 5, the interlock device 90 comprises a driving device 30 and an interlock member 70 driven by driving device 30. In the shown example, the driving device 30 is connected to the charging main shaft 12 and is configured to receive drive force from the charging main shaft 12. Due to the fact that the contact main shaft 20 is driven by the charging main shaft 12, the rotation positions of the charging main shaft 12 is directly associated with the positions of movable contacts of the TSE. Since the driving device 30 is connected to the charging main shaft 12 rather than the contact main shaft 20, a mechanism for driving the interlock device is simplified. It is to be understood that this is merely exemplary rather limited. In some embodiments, the driving device 30 may receive drive force from the contact main shaft.

In some embodiments, as shown in FIG. 5, the driving device 30 includes a first link 32 ratably and eccentrically mounted to the charging main shaft 12 and a transmission assembly driven by the first link 32. Due to the eccentric arrangement of the first link 32, the drivetrain from the charging main shaft 12 to the interlock member 70 can be reduced and the space occupied by the driving device 30 is also reduced. This is advantageous considering the fact that the provision of the interlock device 90 should not impose too much structural complexity on the TSE. The transmission assembly is configured to convert a rotational movement of the charging main shaft 12 to a linear movement for moving the interlock member 70. With such an arrangement, the space occupied by the driving device 30 can be further reduced.

In some embodiments, as shown in FIG. 5, the charging system 10 may be provided on a mounting plate 42 and the mounting plate 42 is provided with a through hole 45. The charging main shaft 12 is disposed on a first side of the mounting plate 42, and the first link 32 extends through the through hole 45 to a second side opposite to the first side, wherein the transmission assembly is disposed on the second side. With such an arrangement, the front side space of the mounting plate 42 can be used for provision of the charging system and the back side space of the mounting plate 42 can be used for interlock device. Thus, the provision of the interlock device does not occupy precious space for the charging system 10 and thus structural efficiency of the TSE is improved.

In some embodiments, as shown in FIG. 5, the transmission assembly comprises a rack and pinion mechanism. The rack and pinion mechanism includes a pinion 33 and a rack 34 that engages with the pinion 33. The first link 32 is eccentrically and rotatably mounted to the pinion 33. During operation of the interlock device, the rotation of the charging main shaft 12 rotates, and the rack 34 moves linearly. It is to be understood that the rack and pinion mechanism is merely exemplary rather limited, in other embodiments, the rack and pinion mechanism may be replaced by other drive mechanisms, such as a chain transmission, a worm and worm wheel mechanism, and the like.

In some embodiments, as shown in FIG. 5, the transmission assembly further comprises a driving member 35. In some embodiments, the driving member 35 is fixed to the linearly moving element, for example to the end of the rack 34. The driving member 35 may include drive portions 352, 354 protruding from the driving member 35 in a direction perpendicular to a linear movement direction of the driving member 35 and the drive portions 352, 354 are configured to actuate the interlock member 70. With the provision of the drive portions 352, 354, the movement of the interlock member 70 can be well controlled.

In some embodiments, as shown in FIG. 5, the driving device 30 further includes a movable body 80 disposed between the driving member 35 and the interlock member 70. The movable body 80 is configured to be driven by the driving member 35 and the interlock member 70 is further moved by the movable body 80. The provision of the movable body 80 can bring about additional control to the interlock member 70. In some embodiments, The movable body 80 is spring-loaded on the TSE and is movably arranged on the TSE and may be movable at an actuating position at which the movable body engages with the interlock member 70 so as to lock the interlock member 70 and an original position at which the movable body disengages from the interlock member 70 so as to unlock the interlock member 70. When the movable body 80 is pushed by the driving member 35, the movable body 80 is moved to the actuating position. When the movable body 80 is not pushed by the driving member 35, the movable body 80 is maintained at its original position for by a spring.

In some embodiments, the movable body 80 may further comprise an actuator, such as an electromagnetic actuator. The electromagnetic actuator is configured to drive the interlock member 70 in response to an input signal to the electromagnetic actuator regardless of a rotation position of the charging main shaft 12. In some embodiments, the movable body 80 may implemented in a form of box and the associated electrical cables for controlling the actuator can be arranged within the box. It is to be understood that actuator may take other forms and the movable body 80 can be implemented as any proper form.

The arrangement of an actuator in the movable body 80 provides additional advantages. This makes it possible to control the movable body 80 to lock the interlock member 70 independently and regardless of the rotation of the charging main shaft 12. This is in particular applicable that the cabinet is provided with the bypass device which comprises two TSEs. When the first TSE and the second TSE both are at OFF position, neither the first TSE nor the second TSE is not allowed to be operated, for example, to be drawn in or out of the cabinet. Under this condition, the movable body 80 is controlled by the actuator (for example, an electromagnetic actuator) to lock the interlock member 70.

In some embodiments, as shown in FIG. 5, the charging main shaft 12 has a first rotation position (i.e., position I) and a second rotation position (i.e., position II) corresponding to an ON state of the first switch and the second switch respectively, and a third rotation position (i.e., position OII) and a fourth rotation position (i.e., position OI) between the first rotation position and the second rotation position which correspond to an OFF state of the first switch and the second switch respectively. In the shown example, four positions, I, OI, OII, II of the charging main shaft 12 are shown. It is to be understood this is illustrative and is related to the number of the charging spring 16. The number of positions of the charging main shaft 12 may vary. The concepts of the present application is also applicable given the teaching here.

In such an embodiment, the interlock member 70 is configured to lock the user interface 50 to prevent the user from operating the user interface 50 when the first switch and the second switch are at the ON state (i.e., at positions I and II). The interlock member 70 is configured to unlock the user interface 50 to allow the user to operate the user interface 50 when the first switch and the second switch are at the OFF state (i.e., at positions OI and OII).

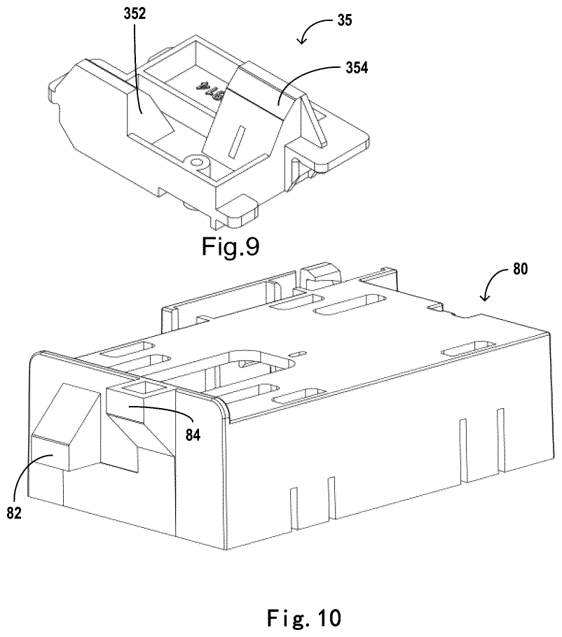

In some embodiments, as shown in FIG. 9, the drive portions 352, 354 comprise a pair of protruding portions sequentially arranged along the linear movement direction. The pair of protruding portions is laterally staggered from each other such that the interlock member 70 is actuated by different protruding portion at different linear positions of the driving member. In the shown example, the drive portions 352, 354 may include inclining drive surface which may occupy less space and can also ensure reliable drive of the associated components. It is to be understood that drive portions 352, 354 may take other proper forms.

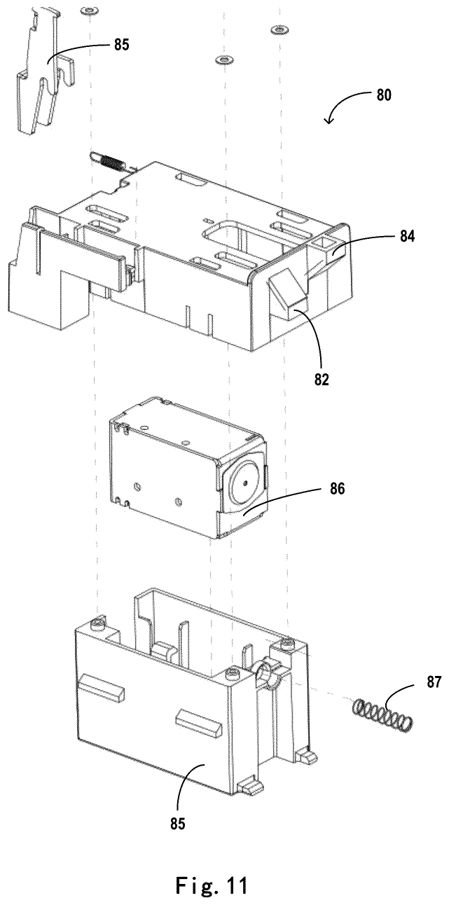

In some embodiments, as shown in FIGS. 10 and 11, the movable body 80 includes matching protruding portions 82, 84 arranged opposite to the drive portions 352, 354. The matching protruding portions 82, 84 are configured to be pushed by the respective protruding portion so as to move the movable body 80 in a direction perpendicular to the linear movement direction. In the shown example, the matching protruding portion 82, 84 may include inclining drive surface which may occupy less space and can also ensure reliable drive of the associated components. It is to be understood that the matching protruding portion 82, 84 may take other proper forms.

In some embodiments, as shown in FIG. 11, the movable body 80 may be implemented as a box form and the movable body 80 comprising a base 85 in form of a box, an actuator 86 arranged within the base, an upper cover 84 including the matching protruding portions 82, 84 at one side. There is a return spring 87 arranged between a side wall of the base 85 and a side wall of the upper cover 84. A rod 85 is spring biased and ratably attached to the upper cover 84. When the matching protruding portions 82, 84 are moved, the rod 85 moves correspondingly. The rod 85 can also be independently driven by the actuator 86 if needed. It is to be understood that the movable body 80 is merely illustrative and it may take other proper forms.

Next, operations of the interlocking device 90 of the present disclosure are described with references to FIGS. 5-8.

As shown in FIG. 5, the charging main shaft 12 is maintained at position II. The position II may be corresponding to the ON state of one switch of the TSE 1. The rack 34 is maintained at an upper position (in FIG. 5's example). A lower drive portion 354 abuts against an upper matching protruding portion 82 of the movable body 80. The interlock member 70 is thus maintained a lock position. An opening of the user interface 50 is closed and a handle 60 is not allowed to be received by the user interface. Accordingly, when one switch of the TSE 1 is at ON state, the user is not allowed to operate the user interface 50.

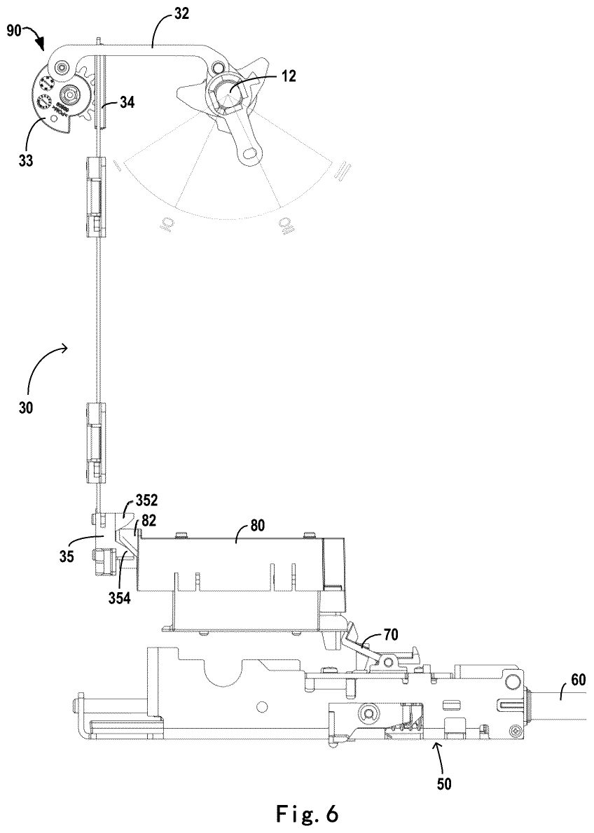

As shown in FIG. 6, the charging main shaft 12 is maintained at position OII. The position OII may be corresponding to the OFF state of one switch of the TSE 1. The rack 34 is maintained at a upper middle position (in FIG. 6's example). Both the matching protruding portion 82, 84 of the movable body 80 are away from the drive portions 352, 354 of the drive assembly 30 and there is no contact between the drive assembly 30 and the movable body 80. Accordingly, the movable body 80 is maintained at its original position by, for example, a spring-return force. Since the movable 80 disengages from the interlock member 70, the interlock member 70 is unlocked and the handle 60 is allowed to be received by the opening in the user interface 50.

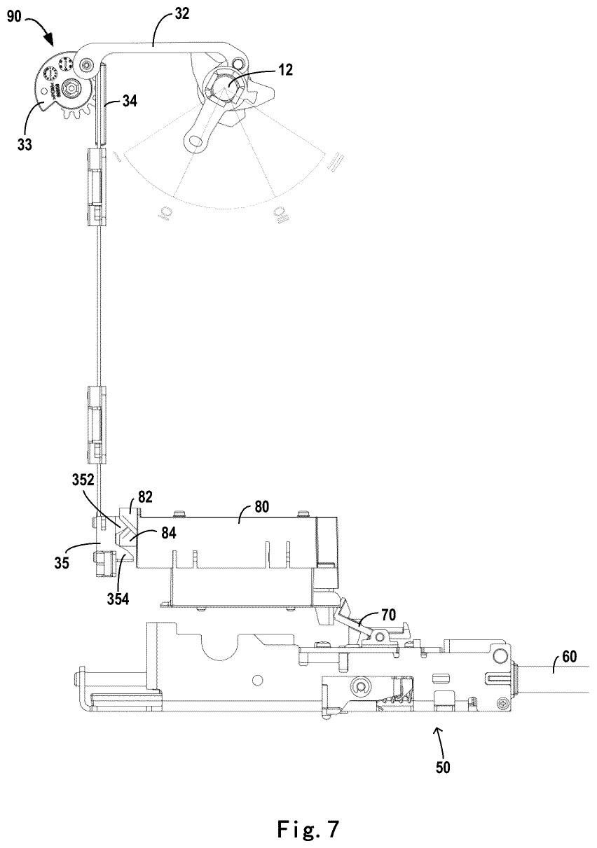

As shown in FIG. 7, the charging main shaft 12 is maintained at position OI. The position OI may be corresponding to the OFF state of one switch of the TSE 1. The rack 34 is maintained at a lower middle position (in FIG. 7's example). Both the matching protruding portion 82, 84 of the movable body 80 are away from the drive portions 352, 354 of the drive assembly 30 and there is no contact between the drive assembly 30 and the movable body 80. Accordingly, the movable body 80 is maintained at its original position by, for example, a spring-return force. Since the movable 80 disengages from the interlock member 70, the interlock member 70 is unlocked and the handle 60 is allowed to be received by the opening in the user interface 50.

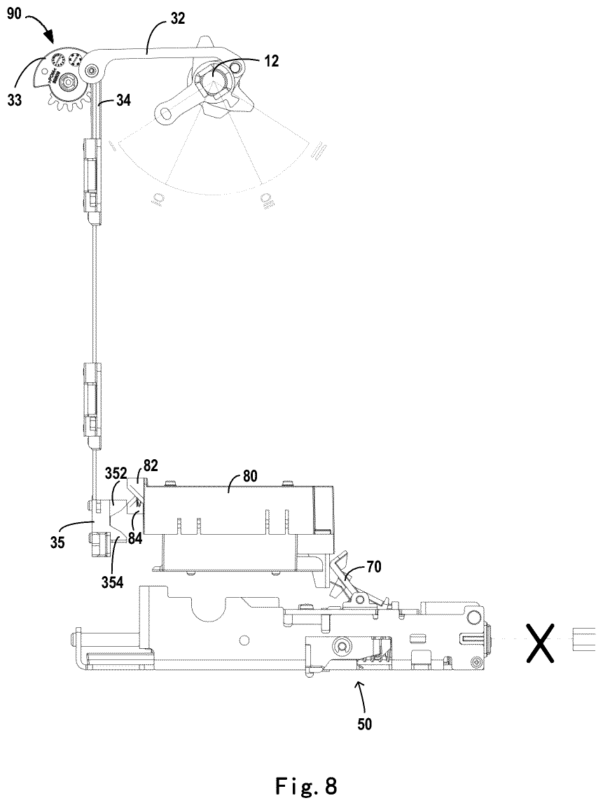

As shown in FIG. 8, the charging main shaft 12 is maintained at position I. The position I may be corresponding to the ON state of one switch of the TSE 1. The rack 34 is maintained at a lower position (in FIG. 5's example). The upper drive portion 352 abuts against a lower matching protruding portion 84 of the movable body 80. The interlock member 70 is thus maintained a lock position. The opening of the user interface 50 is closed and the handle 60 is not allowed to be received by the user interface. Accordingly, when one switch of the TSE 1 is at ON state, the user is not allowed to operate the user interface 50.

When the TSE is a bypass device, the movable body 80 can be independently controlled regardless of the rotation positions of the charging main shaft 12. In some embodiments, even if the charging main shaft 12 is at position OI or OII, the user interface 50 is not allowed to be operated by the user. This may be realized by inputting a signal to the actuator within the movable body 80, a actuating rod of the actuator can be pushed by the actuator so as to lock the interlock member 70. The opening of the user interface 50 is thus closed and the handle 60 is not allowed to be received by the user interface.

According to the present disclosure, the interlock member 70 can by moved by a reciprocating motion of the drive device 30. As the linear position of the drive device 30 is changed by the rotation of the charging main shaft 12, the interlock member 70 can be controlled in a simple way.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. A dual power transfer switch comprising:
a first switch configured to connect a first power source to a load;
a second switch configured to connect a second power source to a load;
a user interface configured to receive a user operating handle for operating the dual power transfer switch; and
an interlock device comprising an interlock member which is adapted to act on the user interface to prevent or allow a user to operate the dual power transfer switch through the user interface in accordance with states of the first switch and the second switch, wherein the interlock member is configured to move to different positions so as to lock or unlock the user interface in dependence on different rotation positions of a main shaft of the dual power transfer switch.

2. The dual power transfer switch of claim 1,
wherein the dual power transfer switch comprises a charging system and a contact system, the charging system comprising a charging main shaft and a charging spring for rotating the charging main shaft, the charging main shaft being configured to drive a contact main shaft of the contact system to switch ON/OFF states of the first switch and the second switch; and
wherein the interlock member is configured by driven by the charging main shaft via a driving device connected thereto.

3. The dual power transfer switch of claim 1, wherein interlock device comprises a driving device,
the driving device comprising:
a first link ratably and eccentrically mounted to the charging main shaft; and
a transmission assembly driven by the first link to convert a rotational movement of the main shaft to a linear movement for moving the interlock member.

4. The dual power transfer switch of claim 3, further comprising a mounting plate for carrying the charging system provided with a through hole, wherein the charging main shaft is disposed on a first side of the mounting plate, and the first link extends through the through hole to a second side opposite to the first side, wherein the transmission assembly is disposed on the second side.

5. The dual power transfer switch of claim 4, wherein the transmission assembly comprises a rack and pinion mechanism including a pinion and a rack that engages with the pinion, the first link being eccentrically and rotatably mounted to the pinion.

6. The dual power transfer switch of claim 3, wherein the transmission assembly further comprises a driving member fixed thereto comprising a drive portion protruding from the driving member in a direction perpendicular to a linear movement direction of the driving member, the drive portion being configured to actuate the interlock member.

7. The dual power transfer switch of claim 6, wherein the driving device further comprises a movable body disposed between the driving member and the interlock member, the movable body being configured to be driven by the driving member and then to move the interlock member.

8. The dual power transfer switch of claim 7, wherein the movable body further comprises an electromagnetic actuator, wherein the electromagnetic actuator is configured to drive the interlock member in response to an input signal to the electromagnetic actuator regardless of a rotation position of the charging main shaft.

9. The dual power transfer switch of claim 7,
wherein the charging main shaft has a first rotation position and a second rotation position corresponding to an ON state of the first switch and the second switch respectively, and a third rotation position and a fourth rotation position between the first rotation position and the second rotation position which correspond to an OFF state of the first switch and the second switch respectively, and
wherein the interlock member is configured to lock the user interface to prevent the user from operating the user interface when the first switch and the second switch are at the ON state; and
the interlock member is configured to unlock the user interface to allow the user to operate the user interface when the first switch and the second switch are at the OFF state.

10. The dual power transfer switch of claim 9, wherein the drive portion comprises a pair of protruding portions sequentially arranged along the linear movement direction, the pair of protruding portions are laterally staggered from each other such that the interlock member is actuated by different protruding portion at different linear positions of the driving member.

11. The dual power transfer switch according to claim 10,
wherein the movable body includes a matching protruding portion arranged opposite to the protruding portion, the matching protruding portion being configured to be pushed by the protruding portion so as to move the movable body in a direction perpendicular to the linear movement direction.

12. The dual power transfer switch of claim 1,
wherein the interlock member is rotatably mounted to the user interface.

13. A power distribution cabinet, comprising:
a first power supply terminal for receiving a first power from a first power supply;
a second power supply terminal for receiving a second power from a second power supply;
a load terminal for providing the first power or the second power to a load;
a dual power transfer switch according to claim 1 configured to selectively connect the first power supply terminal or the second power supply terminal to the load terminal.

14. The dual power transfer switch of claim 2, wherein the interlock member is rotatably mounted to the user interface.

15. The dual power transfer switch of claim 3, wherein the interlock member is rotatably mounted to the user interface.

16. The dual power transfer switch of claim 4, wherein the interlock member is rotatably mounted to the user interface.

17. The dual power transfer switch of claim 6, wherein the interlock member is rotatably mounted to the user interface.

18. The power distribution cabinet of claim 13,
wherein the dual power transfer switch comprises a charging system and a contact system, the charging system comprising a charging main shaft and a charging spring for rotating the charging main shaft, the charging main shaft being configured to drive a contact main shaft of the contact system to switch ON/OFF states of the first switch and the second switch; and
wherein the interlock member is configured by driven by the charging main shaft via a driving device connected thereto.

19. The power distribution cabinet of claim 13,
wherein interlock device comprises a driving device,
the driving device comprising:
a first link ratably and eccentrically mounted to the charging main shaft; and
a transmission assembly driven by the first link to convert a rotational movement of the main shaft to a linear movement for moving the interlock member.

20. The power distribution cabinet of claim 13, wherein the dual power transfer switch further comprises a mounting plate for carrying the charging system provided with a through hole, wherein the charging main shaft is disposed on a first side of the mounting plate, and the first link extends through the through hole to a second side opposite to the first side, wherein the transmission assembly is disposed on the second side.
